(19) United States
(12) Patent Application Publication
(10) Pub. No.: US 2016/0148527 A1
(43) Pub. Date: May 26, 2016

(54) CANOPY FOR A SIMULATION DEVICE

(71) Applicant: Hogan Mfg., Inc., Escalon, CA (US)

(72) Inventors: Donald Morris, Littleton, CO (US); David Johnson, Modesto, CA (US)

(21) Appl. No.: 14/555,464

(22) Filed: Nov. 26, 2014

(51) Int. Cl. G09B 9/12

(52) U.S. Cl. CPC G09B 9/12

(57) ABSTRACT

A simulation device has a capsule that includes a base and a canopy mounted to the base. The canopy is selectively moveable between a first position and a second position such that movement of the canopy from the first position to the second position provides a path of egress from the capsule. A projection surface is disposed on an inner surface of the canopy. The device further includes a seat mounted to the base and a projector mounted above the seat. The projector projects a simulation image on the projection surface when the canopy is in the first position.

### TECHNICAL FIELD

The present disclosure relates to simulators and in particular, to a compact, portable device for simulating motions and a system using images to simulate a sensory experience.

### BACKGROUND

In order to create a realistic experience, modern flight simulators include photorealistic visual effects, surround sound, and synchronized motion. Such simulation technology is also used in the entertainment field. For example, amusement parks use simulators to provide customers with thrill rides that give the experience of loops, turns, and anti-gravitational effects.

Known simulators typically have a capsule or cabin within which operators or passengers sit during a simulation. These capsules include one or more projectors that project moving images onto screens positioned within the capsule to give passengers the experience of motion. The screens are normally positioned at the front of the capsule interior, with additional screens often provided along the sides of the capsule interior to provide a wider field of view.

In addition to the screens and seating areas, the capsules also include one or more doors to provide an ingress or egress point for the passengers. Such doors typically rotate outwardly about a vertical hinge. Because the simulator capsules must accommodate the aforementioned screens, door or doors, and passenger seating areas, the capsules are often quite large. When combined with the various systems used to impart motion to the capsule, the overall size of the simulation devices becomes even larger. As a result, known simulators are usually not portable, but are instead permanently installed in the location in which they are to be used.

While permanent installations are suitable in many instances, it would be desirable to have a simulator that is easily moved. Such simulators could be moved to accommodate a customer's temporary needs or to be part of an event that changes location, such as an air show. Accordingly, there is a need for a simulation device and system that utilizes images projected within a capsule to simulate an event, wherein the capsule is compact to allow for the device to be easily moved without excessive disassembly and reassembly.

### SUMMARY

In a first exemplary embodiment of a simulation device, a capsule includes a base and a canopy mounted to the base. The canopy is selectively moveable between a first position and a second position such that movement of the canopy from the first position to the second position provides a path of egress from the capsule. A projection surface is disposed on an inner surface of the canopy. The simulation device further includes a seat mounted to the base and a projector mounted above the seat. The projector projects a simulation image on the projection surface when the canopy is in the first position.

A second exemplary embodiment of a simulation device includes a platform and a capsule. The capsule has a base that is mounted to the platform. A canopy is rotatably mounted to the base and is selectively moveable between a raised position and a lowered position. The canopy has a projection surface disposed on an inner surface. A seat is mounted to the base, and a projector is mounted above the seat. The projector projects a simulation image on the projection surface when the canopy is in the lower position.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 shows an isometric view of an exemplary embodiment of a simulation device in accordance with the present disclosure, wherein the device has a canopy in an open position;

FIG. 2 shows an isometric view of the simulation device of FIG. 1 with the canopy in a closed position;

FIG. 3 shows an isometric view of the simulation device of FIG. 2 with an outer shell of the canopy removed;

FIG. 4 shows an isometric view of the simulation device of FIG. 2 with the canopy removed;

FIG. 5 shows a side cross-sectional view of the simulation device of FIG. 2;

FIG. 6 shows a top cross-sectional view of the simulation device of FIG. 5 with projectors removed;

FIG. 7 shows a top cross-sectional view of the simulation device of FIG. 5;

FIG. 8 shows a partial isometric view of the simulation device of FIG. 1; and

FIG. 9 shows a partial cross-sectional view of the simulation device shown in FIG. 5.

### DETAILED DESCRIPTION

Exemplary embodiments of the disclosed subject matter will now be described with reference to the accompanying drawings wherein like numerals correspond to like elements. Exemplary embodiments of the present invention are directed to motion simulators and more specifically, to portable motion simulators having a capsule mounted to a motion platform. In particular, several embodiments of the present disclosure are directed to capsules having movable canopies to provide a path for passenger ingress and egress, wherein simulation images are projected onto an interior surface of the canopy.

The following discussion proceeds with reference to examples of simulator capsules that can accommodate one or more operators or passengers. While the examples provided herein have been described with reference to application to flight simulators, it will be apparent to one skilled in the art that this is done for illustrative purposes and should not be construed as limiting the scope of the disclosure, as claimed. Thus, it will be apparent to one skilled in the art that aspects of the present disclosure may be employed with any other simulation devices in which it is desirable to impart the visual impression of motion to operators or passengers in order to provide a realistic experience for amusement rides, automotive simulators, and the like. Further, it will be appreciated that the disclosed simulator capsules are suitable for use with stationary platforms, as well as platforms that move the capsule in order to simulate forces felt during a simulated experience. In this regard, the use of motion in combination with visual simulation images has been utilized in various simulation devices. For example, U.S. Pat. No. 5,388,991, issued to Morris, the disclosure of which is expressly incorporated herein, teaches using vertical acceleration, pitch, and roll in combination with photorealistic images to simulate the motions associated with high speed looping roller coasters, bobsled rides, water rides, flying rides, driving rides, and the like.

The exemplary embodiments are described with reference to operators; however, it should be appreciated that the disclosure is not limited to embodiments in which the occupant actively provides input to the simulation device. In this regard, the user may be a passive occupant. Further, the simulation device is not limited to any particular number of users. Various embodiments that accommodate any number of passive or active occupants, or any combination thereof, are contemplated and should be considered within the scope of the present disclosure.

The detailed description may use illustrative terms such as vertical, horizontal, forward, rearward, pitch, roll, etc. However, these terms are descriptive in nature and should not be construed as limiting. Further, it will be appreciated that embodiments of the present invention may employ any combination of features described herein.

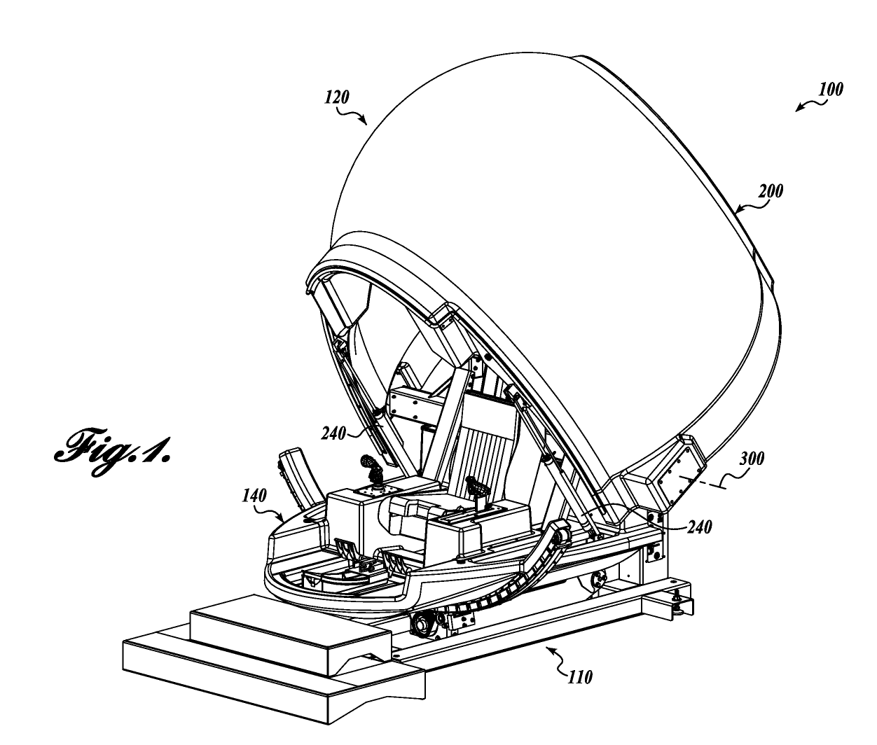

FIG. 1 shows an isometric view of an exemplary embodiment of a simulation device 100 in accordance with the present disclosure. The device 100 includes a capsule 120 mounted to a platform 110. The platform 110 optionally includes a motion system 112 to impart motion to the capsule 120 to enhance the simulated experience.

The capsule 120 has a canopy 200 mounted to a capsule base 140. In the illustrated embodiment, the canopy 200 is rotatably mounted to the capsule base 140 to provide ingress and egress for the user. The components of the capsule 120 are preferably made from lightweight materials, such as fiberglass, graphite, or aluminum; having suitable strength and durability; however alternate materials may be utilized to provide adequate strength or other desirable material properties for particular components.

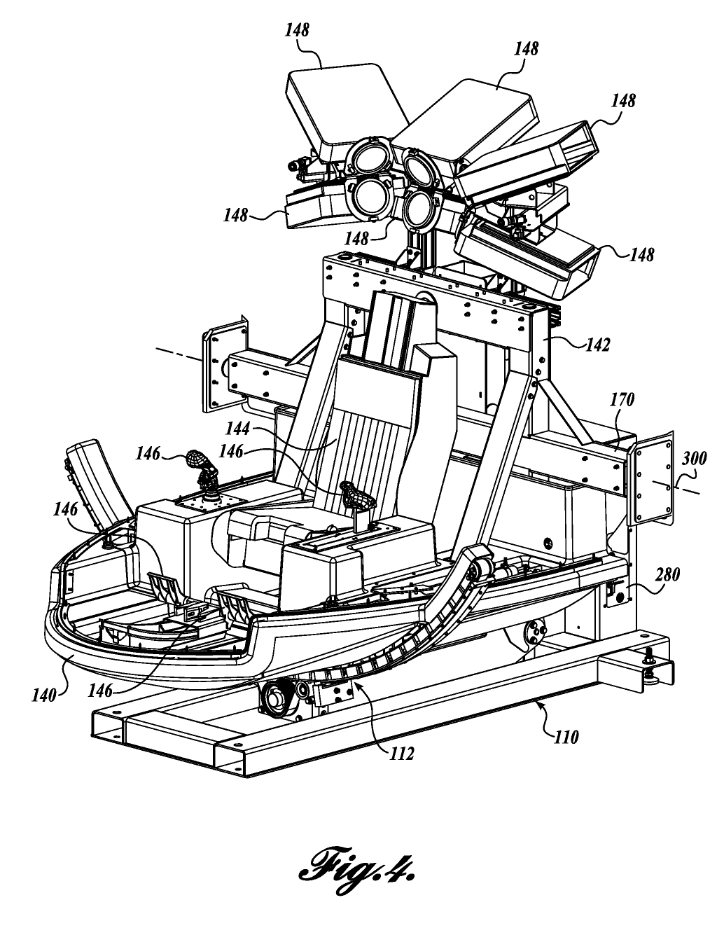

As best shown in FIG. 4, a seat 144 and operator input devices 146 are mounted to the capsule base 140. In the illustrated embodiment, the seat 144 and input devices 146 are configured to simulate various controls found in an airplane cockpit; however, it will be appreciated that the capsule 120 can include any suitable number and type of components to simulate various environments, and such variations should be considered within the scope of the present disclosure.

A plurality of high resolution projectors 148 are mounted to a frame 142 to be positioned above the seat 144 at a rear portion of the capsule 120. The projectors 148 preferably project photorealistic images over the head of the occupant onto a projection surface 222, located on an interior surface of the canopy 200, thereby providing the occupant with a visual representation of the event being simulated.

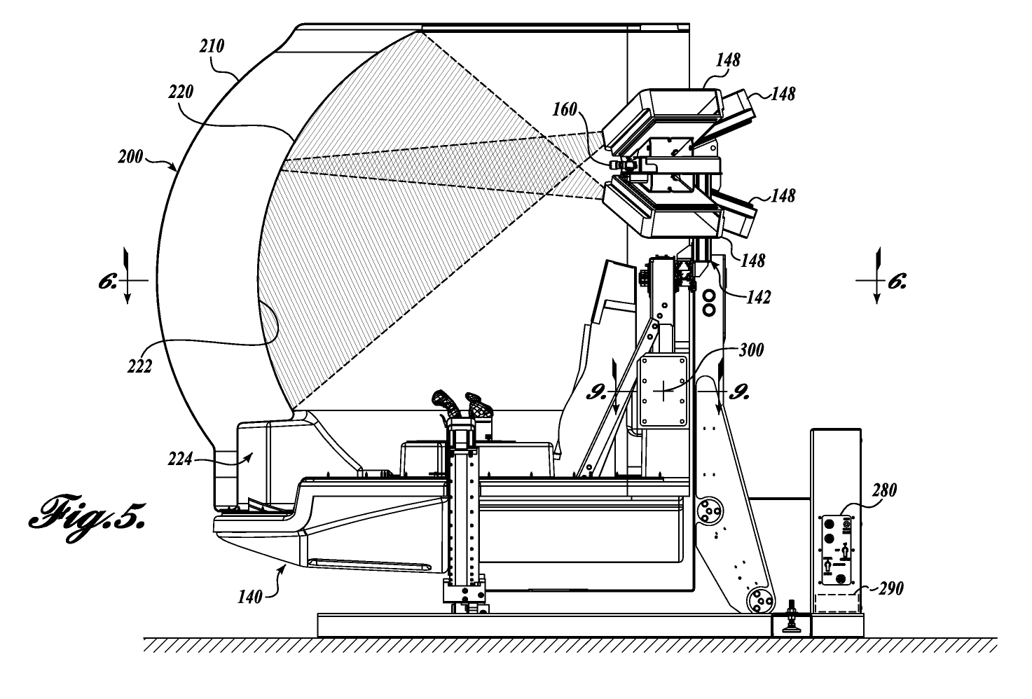

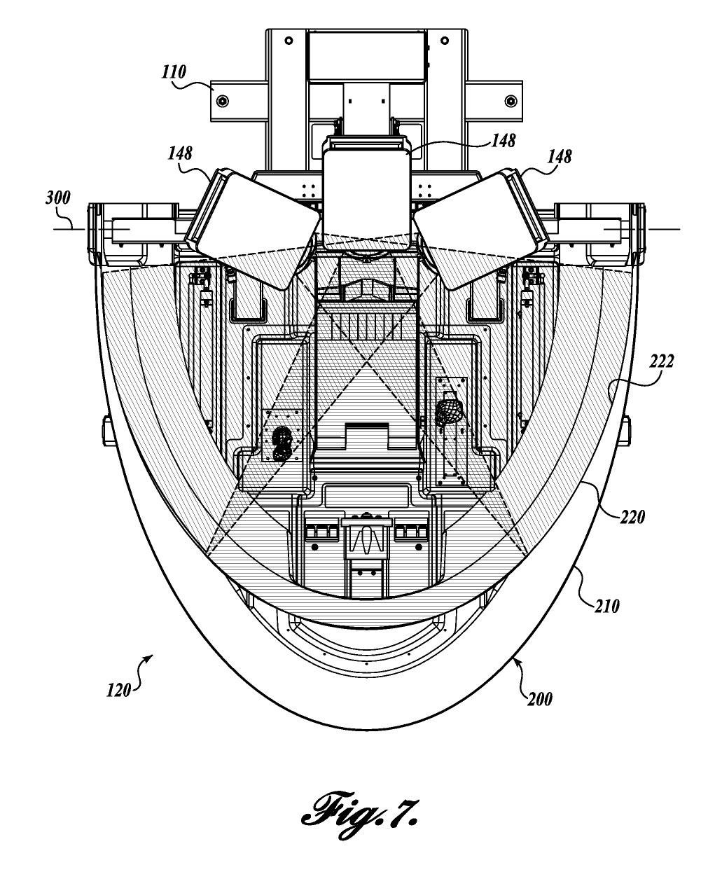

In the illustrated embodiment, six (6) projectors are utilized. As shown in FIGS. 5 and 7, three upper projectors 148 project images onto a lower portion of the projection surface 222 and three (3) lower projectors 148 project images onto an upper portion of the projection surface. The upper and lower center projectors 148 project images straight ahead. The upper and lower right side projectors 148 project images to the left side of the projection surface 222, and the upper and lower left side projectors 148 project images to the right side of the projection surface 222. It will be appreciated that the number, type, and location of the projectors can vary, and should be considered within the scope of the present disclosure.

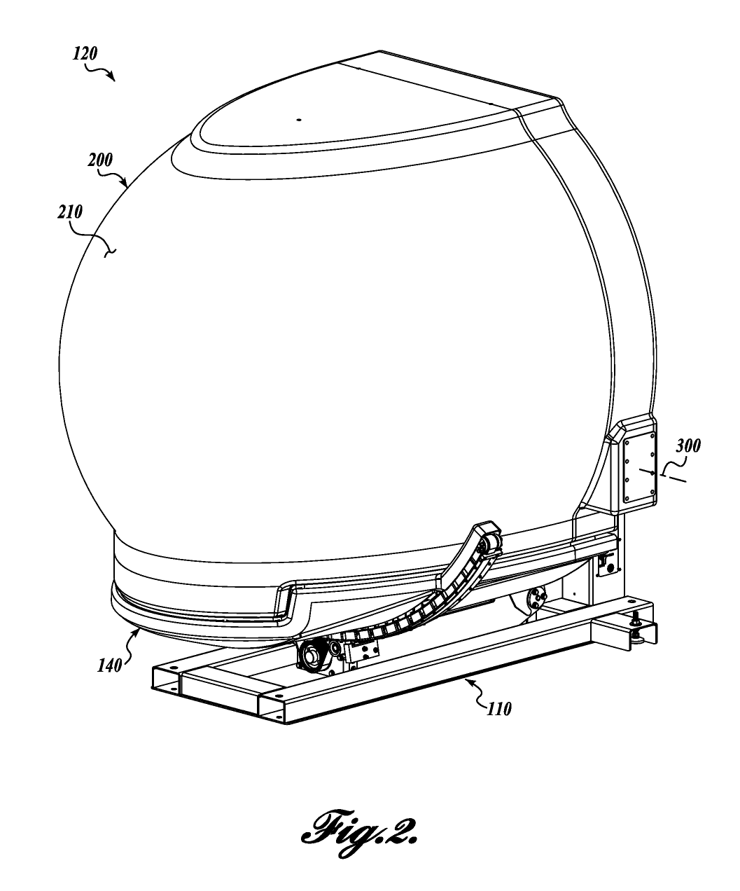

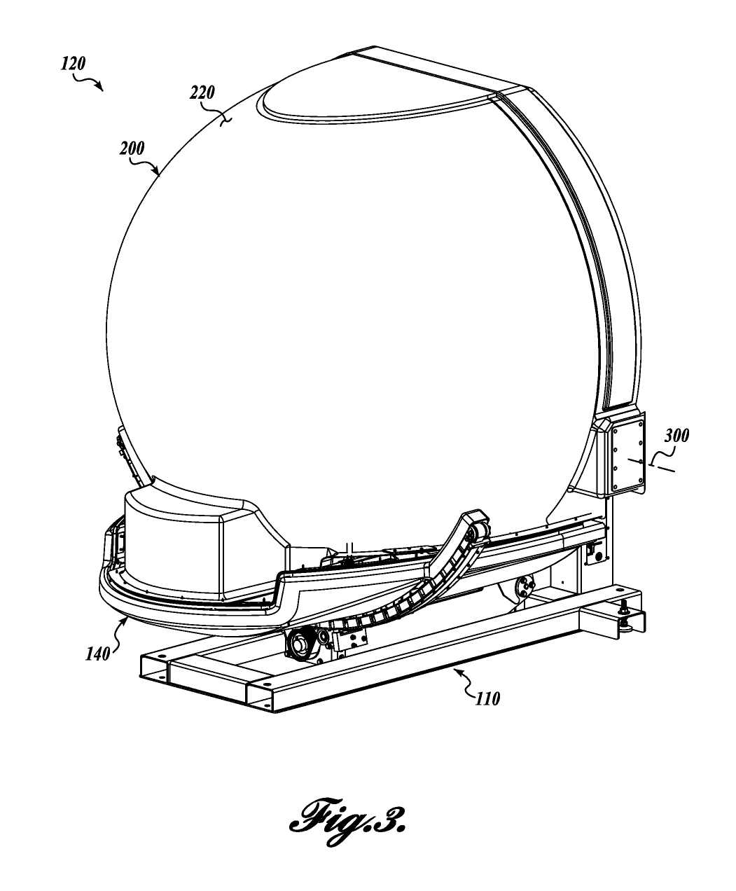

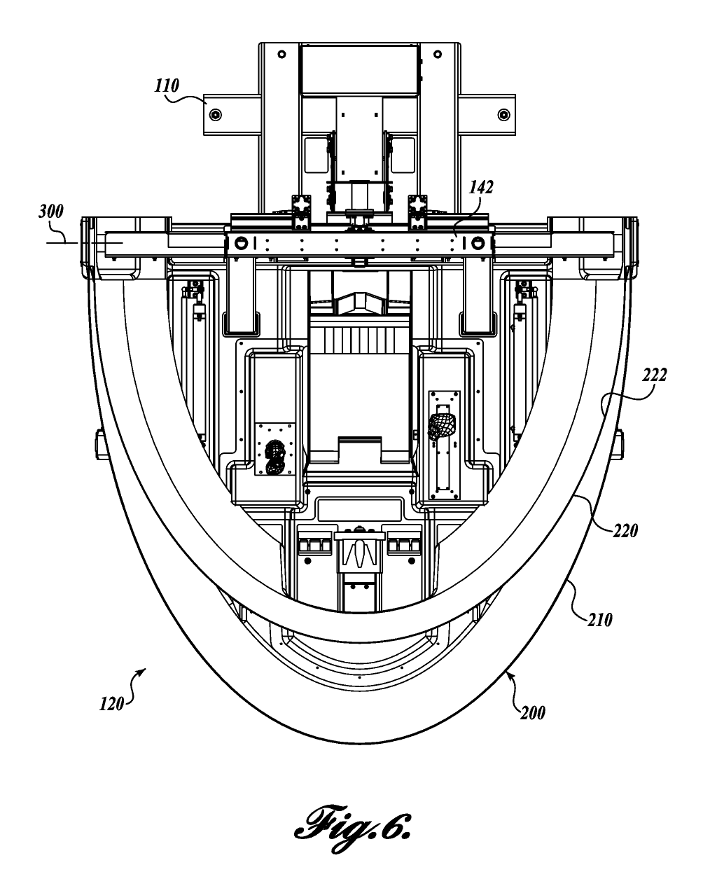

Referring now to FIGS. 2, 3, 5, and 6, the canopy 200 includes an outer shell 210 offset from an inner shell 220. The outer and inner shells 210 and 220 are preferably made from fiberglass. Structural reinforcements are made from suitable materials using well-known methods in order to provide the outer and inner shells 210 and 220 with suitable strength and durability, while maintaining a generally lightweight construction. It will be appreciated that the configuration and component materials of the outer and inner shells 210 and 220 can vary within the scope of the present disclosure.

The outer shell 210 is largely cosmetic, providing a sleek, aesthetically pleasing appearance from the exterior of the simulation device 100. The inner shell 220 is preferably sized and configured to approximate a user's surroundings for a particular simulation, e.g., the cockpit of a particular airplane to be simulated. It will be appreciated, however, that much of the interior appearance of the capsule is provided by the images projected onto the projection surface 222 by the projectors 148. Accordingly, the inner shell can be of a more generic shape, relying on the projected images to provide the interior appearance of a particular airplane, automobile, roller coaster car, etc.

In the illustrated embodiment, the inner shell 220 is offset from the outer shell 210 such that a gap exists between the inner and outer shells. This space allows for the inclusion of a foot well 224, as shown in FIG. 5, so that an operator or passenger can extend his legs under the display, similar to an actual cockpit. Further, the space between the inner and outer shells 220 and 210 provides an area through which wire runs, air vents, etc. can be routed without being visible from the exterior or interior of the capsule 120.

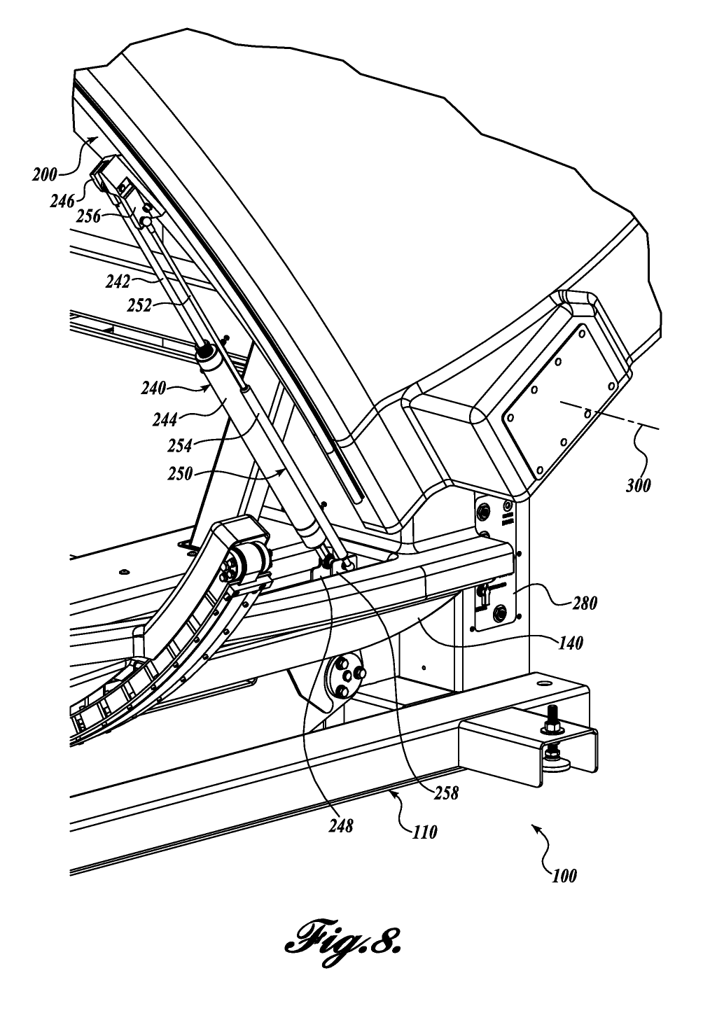

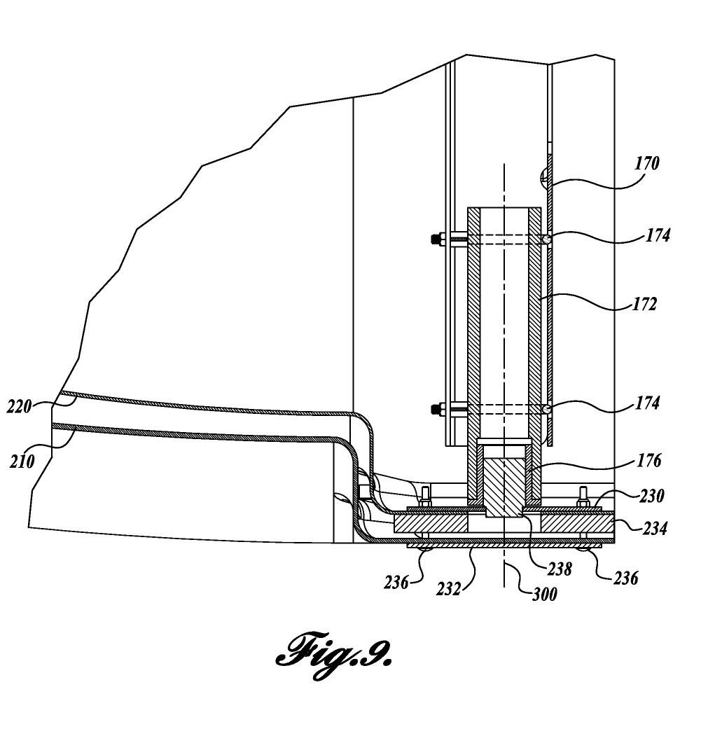

Turning now to FIGS. 8 and 9, the canopy 200 is rotatably coupled to the capsule base 140 about an axis 300 so that the canopy is rotatable between a raised, open position (FIG. 1) and a lowered, closed position (FIG. 2). In the illustrated embodiment, a trunnion 238 is located on each side of the capsule 120. The trunnions 238 are coaxially positioned and cooperate to couple the canopy 200 to the capsule base 140. Referring specifically to FIG. 9, the trunnion 238 located on one side of the capsule 120 will be described with the understanding that the other trunnion 238, located on the opposite side of the capsule 120, has a similar configuration.

The trunnion 238 extends inwardly from the canopy 200. The trunnion 238 is press fit or otherwise secured to a mounting plate 230 positioned on an interior surface of the inner shell 220. The mounting plate 230 is secured to the canopy 200 with a plurality of known fasteners 236. An end plate 232 is positioned on an exterior surface of the canopy 200, and one or more spacers 234 are positioned between the inner and outer shells 220 and 210 to provide sufficient strength to the canopy 200 at the trunnion connection.

The trunnion 238 is coupled to a crossmember 170 that is fixedly secured relative to the capsule base 140. A sleeve 172 is mounted within an interior portion of the crossmember 170 by a pair of U-bolts 174. A flanged bushing 176 is mounted to the outer end of the sleeve 172, and the trunnion 238 extends into the bushing. Thus, the trunnion 238 and, therefore, the canopy 200 are rotatably supported at each end relative to the capsule base 140.

It will be appreciated that the disclosed trunnion 238 configuration is exemplary only and should not be considered limiting. In this regard, any suitable configuration for rotatably coupling the canopy 200 to the capsule base 140 can be utilized. Further, the connection between the canopy 200 and the capsule base 140 is not limited to a rotational connection. In this regard, the movement of the canopy 200 relative to the capsule base 140 can also include translation or a combination of translation and rotation, as might be provided by a linkage or other suitable connection. It should therefore be appreciated that any number of suitable configurations for moving the canopy 200 between an open position and a closed position are possible and should be considered within the scope of the present disclosure.

Referring to FIGS. 1, 8, and 9, an actuator 240 is positioned on each side of the canopy 200 to move the canopy between the raised and lowered positions. In the illustrated embodiment, the actuator 240 is a linear actuator having a rod 242 disposed within a cylinder 244. The rod 242 is rotatably coupled to the canopy 200 with a first fitting 246, and the cylinder 244 is rotatably coupled to the capsule base 140 with a second fitting 248. When the rod 242 extends from the cylinder 244, the actuator 240 drives the canopy 200 about axis 300 toward the raised position. When the rod 242 retracts into the cylinder 244, the actuator 240 drives the canopy 200 about axis 300 toward the lowered position. It will be appreciated that the orientation, number, type, and location of the actuators can vary. In this regard, rotary actuators, hydraulic actuators, pneumatic actuators, electrically driven actuators, or any other suitable type of actuator mounted to rotate the canopy 200 about axis 300 can be utilized and should be considered within the scope of the present disclosure.

An operator can raise or lower the canopy 200 using a control panel 280 located on the outside of the simulation device 100, inside the capsule (not shown), or remotely. The control panel and other control devices are operably connected to a controller 290, shown in FIG. 5, that controls the actuator 240 to raise and lower the canopy 200 in accordance with input provided to the control panel 280.

The capsule preferably includes a counterbalance to reduce the force required from the actuators 240 to rotate the canopy 200. The weight of the canopy 200 produces a moment about axis 300 that tends to rotate the canopy toward the lowered position. The counterbalance provides a force that tends to rotate the canopy 200 in the opposite direction, thereby reducing the load on the actuators. This in turn allows for more compact actuators and/or extends actuator life. In the illustrated embodiment, the counterbalance includes a gas spring 250 having a rod 252 partially disposed within a cylinder 254. The rod 252 is rotatably coupled to the canopy 200 by a fitting 256, and the cylinder 254 is rotatably coupled to the capsule base 140 by another fitting 258. It will be appreciated that the counterbalance is not limited to a gas spring, but can instead utilize a coil spring, a torsion spring, or any other suitable spring to apply a biasing force to the canopy 200 that tends to rotate the canopy toward the raised position. Further, the number and position of the counterbalance springs can vary within the scope of the present disclosure.

The illustrated embodiment is configured for use as a single occupant flight simulator. Other embodiments in which the number, type, and locations of the seats and operator controls vary to accommodate different numbers of users and to simulate different situations are contemplated. Further, the number and locations of the projectors, as well as the images projected within the capsule can vary to provide difference simulations. These and other variations are contemplated and should be considered within the scope of the present disclosure.

The projection surface 222 is preferably formed by coating the inside of the inner shell 220 with a highly reflective acrylic paint, as is commonly utilized in the video projection industry. In this manner, the projection surface 222 is integral with the inner shell 220. It will be appreciated that other coatings can be utilized to form the projection surface 222. Further, embodiments are contemplated in which the projection surface 222 is formed separate from the inner shell 220 and is later attached using fasteners, adhesives, or any other suitable configurations.

The projection surface 222 can also have different contours. For embodiments in which the projection surface 222 is formed by applying a reflective coating to the inner shell 220, the shape of the inner shell can be designed to have a particular profile in the area of the projection surface. For embodiments in which the projection surface 222 is formed separate from the inner shell 220, the projection surface can be formed into a desired shape prior to or during installation. Various embodiments are contemplated in which parts or all of the projection surface 222 are flat, have a constant radius, have an elliptical or parabolic cross-section, or are of any suitable shape to be utilized in a simulation environment. Further some or all of the projection surface 222 can be concave or convex. It will be appreciated that the present disclosure is not limited to projection surfaces 222 having a particular shape, and the inclusion of one or more projections surfaces 222 of any suitable size and shape should be considered within the scope of the present disclosure.

Because the projection surface 222 is integral with the canopy 200, and the canopy is raised and lowered to provide a path of ingress and egress for passengers, the presently disclosed simulation device allows for a compact capsule 120 that makes efficient use of space. As a result, the capsule 120 is suitable for use with portable simulation devices. It is also contemplated that the capsule 120 can be used with fixed installations.

While illustrative embodiments have been illustrated and described, it will be appreciated that various changes can be made therein without departing from the spirit and scope of the invention.

1. A simulation device, comprising:
(a) a capsule having a base;
(b) a canopy mounted to the base and selectively moveable between a first position and a second position, wherein movement of the canopy from the first position to the second position provides a path of egress from the capsule, the canopy having a projection surface disposed on an inner surface;
(c) an actuator coupled to the canopy to selectively apply a first force to the canopy to move the canopy in a first direction and to selectively apply a second force to the canopy to move the canopy in a second direction;
(d) a seat mounted to the base; and
(e) a projector mounted above the seat, the projector projecting a simulation image on the projection surface when the canopy is in the first position.

2. The simulation device of claim 1, wherein the canopy is lowered in the first position and raised in the second position.

3. The simulation device of claim 1, wherein the canopy is rotatably mounted to the base about an axis.

4. The simulation device of claim 3, wherein the canopy comprises a trunnion supporting the canopy to rotate about the axis.

5. The simulation device of claim 4, wherein the trunnion extend inwardly from the canopy.

6. The simulation device of claim 3, wherein the actuator selectively rotates the canopy in a first direction and a second direction about the axis.

7. The simulation device of claim 6, wherein the actuator is a linear actuator.

8. The simulation device of claim 7, wherein a first end of the linear actuator is rotatably coupled to the canopy.

9. The simulation device of claim 6, further comprising a counterbalance operably coupled to the canopy, the counterbalance applying a biasing force to the canopy to bias toward one of the first position and the second position.

10. The simulation device of claim 9, wherein the counterbalance comprises a gas spring operably coupled to the canopy.

11. The simulation device of claim 1, further comprising a counterbalance operably coupled to the canopy, the counterbalance applying a biasing force to the canopy to bias the canopy toward the second position.

12. A simulation device, comprising:
(a) a platform;
(b) a capsule comprising a base mounted to the platform;
(c) a canopy rotatably mounted to the base and selectively moveable between a raised position and a lowered position, the canopy having a projection surface disposed on a first portion of an inner surface of the canopy, a second portion of the inner surface being shaped to simulate a particular environment;
(d) a seat mounted to the base; and
(e) a projector mounted above the seat, the projector projecting a simulation image on the projection surface when the canopy is in the lower position, the simulation image corresponding to the particular environment simulated by the second portion of the inner surface, wherein the platform moves the capsule during a simulation, movement of the capsule corresponding to the simulation image on the projection surface.

13. The simulation device of claim 12, wherein movement of the capsule during the simulation imparts a force on an occupant, the force corresponding to the simulation image on the projection surface.

14. The simulation device of claim 13, further comprising an actuator operably coupled to the canopy to move the canopy between the raised position and the lowered position.

15. The simulation device of claim 14, wherein the actuator is a linear actuator, a first end of the linear actuator being coupled to the canopy, a second end of the linear actuator being coupled to the base.

16. The simulation device of claim 12, further comprising a counterbalance, the counterbalance applying a biasing force to the canopy that tends to rotate the canopy toward the raised position.

17. The simulation device of claim 16, wherein the counterbalance is a spring having a first end operably coupled to the canopy and a second end operably coupled to the base.

18. The simulation device of claim 17, wherein the spring is a gas spring.

19. The simulation device of claim 12, wherein the projection surface comprises a reflective paint applied to a surface on the capsule.
